(19) United States
(12) Patent Application Publication
(10) Pub. No.: US 2025/0236345 A1
(43) Pub. Date: Jul. 24, 2025

(54) Reinforcement Device

(71) Applicant: Zephyros, Inc., Romeo, MI (US)

(72) Inventors: Milko Dimovski, Romeo, MI (US); Liwen Li, Romeo, MI (US); Ron Cullimore, Romeo, MI (US); Jeffery Shantz, Romeo, MI (US)

(21) Appl. No.: 18/881,852

(22) PCT Filed: Aug. 16, 2023
(86) PCT No.: PCT/US2023/030334

§ 371 Date: Jan. 7, 2025

Related U.S. Application Data
(60) Provisional application No. 63/399,147, filed on Aug. 18, 2022.

(51) Int. Cl. B62D 29/00; B62D 25/00

(52) U.S. Cl. CPC B62D 29/002; B62D 25/00

(57) ABSTRACT

A structural reinforcement (20) for a vehicle cavity (10) comprising a carrier (30) including: a base wall (40) and a plurality of continuous vertical reinforcement structures (50) that span from a bottom carrier surface (32) to a top carrier surface (34) and a plurality of horizon reinforcement structures (60); a protrusion structure (70) projecting from the base wall (40) including a vertical protrusion outer wall (72) with a first adhesive (80) disposed thereon, wherein the protrusion outer wall (72) protrudes through an opening (12) in a wall of the vehicle cavity (10); a second adhesive (90) disposed on peripheral portions of the carrier (30) including a portion of the bottom surface (32) of the carrier; wherein the first adhesive (80) is in shear and the second adhesive (90) that is disposed on the portion of the bottom surface is in compression during a roof crush event.

This application claims priority to U.S. provisional application 63/399,147 filed on Aug. 18, 2022, which is incorporated by reference in its entirety for all purposes.

### FIELD OF THE INVENTION

The present invention relates generally to reinforcement of structures, and more particularly to reinforcement of vehicle structures using structural reinforcements having improved roof crush and side impact crash performance in combination with lighter weight materials.

### BACKGROUND OF THE INVENTION

In various locations throughout transportation vehicles, recent years have seen the increased use of structural reinforcements in which vehicle cavities are commonly fitted with structural reinforcements that aid in controlling deformation and/or channeling the loads from a roll over or an impact. With the advent of electric vehicles with substantial battery packs added to the vehicle, the resulting crash/crush load scenarios have presented new challenges for the structural reinforcements. For some applications, it has become popular in recent years to employ a carrier structure in combination with a secondary material, such as an expandable adhesive material as part of the reinforcement. See e.g., U.S. Pat. Nos. 6,932,421; 6,921,130; 6,920,693; 6,890,021; and 6,467,834 all incorporated by reference. Often, these structures are manufactured using injection molding and/or co-extrusion.

Structural reinforcements that include multiple different materials to meet multiple goals (e.g., reinforcement and sealing) can be found in U.S. Pat. Nos. 10,196,097 and 10,173,727 among others. However, there remains a need for innovative products that provide solutions to the new challenges for the crash/crush load scenarios found with electric vehicles while still using materials that minimize weight and cycle time during production.

### SUMMARY OF THE INVENTION

The present teachings meet one or more of the above needs by the improved devices and methods described herein.

In one aspect, the present teachings pertain to a structural reinforcement for a vehicle cavity comprising a carrier including a base wall and a plurality of continuous vertical reinforcement structures that span from a bottom carrier surface to a top carrier surface and a plurality of horizon reinforcement structures; a protrusion structure projecting from the base wall including a vertical protrusion outer wall with a first adhesive disposed thereon and two protrusion vertical side walls, wherein the protrusion outer wall protrudes through an opening in a wall of the vehicle cavity; a second adhesive disposed on peripheral portions of the carrier including a portion of the bottom surface of the carrier; wherein the first adhesive is in shear and the second adhesive that is disposed on the portion of the bottom surface is in compression during a roof crush event or when a force is applied in a shear vector.

In another aspect of the present teachings, it is contemplated that additionally one or more are true-wherein the continuous vertical reinforcement structures are ribs that are about 3 to 5 mm in thickness; the roof crush event subjects the carrier to loads nearly parallel to the vertical reinforcement structures and the first adhesive and nearly perpendicular to the second adhesive; the first adhesive and second adhesive are the same composition of expandable structural adhesive; a third adhesive is disposed about the carrier around a top portion and comprises an expandable sealant; the plurality of horizon reinforcement structures are ribs that are at least 30 percent thinner than the ribs of the vertical reinforcement structures; the protrusion structure includes a plurality of snap features that secure the carrier to the opening in the wall of the vehicle cavity and maintain a set distance of the first adhesive to a vehicle reinforcement panel; the second adhesive is located onto a portion of the carrier that substantially surrounds the protrusion structure; the adhesive material is applied to the carrier prior to or after insertion of the structure into a vehicle cavity; the first adhesive material, the second adhesive, or both expands upon exposure to a stimulus; the expandable sealant expands upon exposure to a stimulus and wherein the two vertical side walls are coextensive with two of the plurality of continuous vertical reinforcement structures.

In yet another aspect, the present teachings pertain to a structural reinforcement for a vehicle cavity comprising a carrier including a base wall and a plurality of continuous vertical reinforcement structures that span from a bottom carrier surface to a top carrier surface and a plurality of horizon reinforcement structures; a protrusion structure projecting from the base wall including a vertical protrusion outer wall with a first adhesive disposed thereon and two protrusion vertical side walls that are coextensive with two of the continuous vertical reinforcements, wherein the protrusion outer wall and the two protrusion vertical side walls protrudes through an opening in a wall of the vehicle cavity; a second adhesive disposed on peripheral portions of the carrier including a portion of the bottom surface of the carrier; wherein the first adhesive is in shear and the second adhesive that is disposed on the portion of the bottom surface is in compression during a roof crush event.

### DESCRIPTION OF THE DRAWINGS

FIG. 1 is a perspective view of the present teachings with the reinforcement structure shown in dashed line in situ in the vehicle cavity.

FIG. 2 is an exploded perspective view of FIG. 1.

FIG. 3 is a perspective view of the present teachings with the reinforcement structure shown in dashed line in situ in the vehicle cavity from the opposing side of FIG. 1.

FIG. 4 is an exploded perspective view of FIG. 3.

FIG. 5 is a sectional view of FIG. 3

FIG. 6 is a perspective view of the exemplary reinforcement structure of the present teachings.

FIG. 7 is a perspective view of the exemplary reinforcement structure of the present teachings from the opposing side (of FIG. 6).

FIG. 8 is another perspective view of the exemplary reinforcement structure of the present teachings from the opposing side (of FIG. 6).

FIG. 9 is a partial sectional perspective view of FIG. 8

FIG. 10 is a side view of the exemplary reinforcement structure of the present teachings, showing the locations of the sections for FIGS. 11-13.

FIGS. 11-13 are sectional views of the exemplary reinforcement structure of the present teachings.

### DETAILED DESCRIPTION

The present teachings relate to a structural reinforcement for a vehicle cavity comprising a carrier and two or more adhesives.

The carrier may include a base wall and a plurality of reinforcement structures. It is contemplated that one or more of the plurality of reinforcements may be vertical reinforcement structures, horizontal structures, diagonal structures, or a combination thereof.

It is contemplated that these reinforcement structures may be in the form of ribs. The ribs may be integral to and molded as part of the carrier. The ribs may be an added secondary component. The ribs may be a combination of integral and added component.

It is contemplated that at least some of the vertical reinforcement structures are contiguous between the bottom and top surface of the carrier. It is contemplated that the vertical reinforcement structures may be non-contiguous and only span a portion of the carrier.

It is contemplated that at least some of the horizontal reinforcement structures are contiguous between the side surfaces of the carrier. It is contemplated that the horizontal reinforcement structures may be non-contiguous and only span a portion of the carrier.

It is contemplated that the carrier includes a protrusion structure that is cantilevered from and projects beyond a main body portion of the carrier. The protrusion structure having two protrusion side walls. The two vertical side walls may be coextensive with two of the plurality of continuous vertical reinforcement structures. There may be a center wall disposed between the two vertical side walls. The center wall may be coextensive with its respective continuous vertical reinforcement structure.

The protrusion structure having a vertical protrusion outer wall. The outer wall may be flat (planar). The outer wall may include a stepped surface with two or more horizontally off-set planar surfaces. The outer wall may include one or more ridges to aid in directing the flow of at least one of the two or more adhesives during an expansion event. It is contemplated that the protrusion outer wall protrudes through an opening in a wall of the vehicle cavity.

The outer wall may include a first adhesive disposed thereon. The first adhesive may cover substantially the entire planar surface of the outer wall. The first adhesive may cover a portion of the planar surface. Preferably, the first adhesive covers at least about 50% or more of the surface of the outer surface. The adhesive may have at least an unexpanded thickness of about 1.5 to 3.5 mm. The first adhesive when subject to a roof crush load (vertical load/shear vector) is in shear.

It is contemplated that the second adhesive disposed on peripheral portions of the carrier. The second adhesive disposed upon a portion of the bottom surface of the carrier. The second adhesive that is disposed on the portion of the bottom surface is in compression when a force is applied in a shear vector.

The continuous vertical reinforcement structures include ribs that are about 3 to 5 mm in average thickness along their length. Any other ribs may have an average thickness that differs from the average thickness of vertically oriented ribs elsewhere in the reinforcement. It is contemplated that the plurality of horizon reinforcement structures are ribs that have an average thickness that is at least 30 percent thinner than the ribs of the vertical reinforcement structures.

The reinforcement is configured to provide improved resistance to shear (as compared with a vehicle that omits such reinforcement) in response to roof crush loads. Preferably a force applied in a shear vector subjects the carrier to loads nearly parallel to the vertical reinforcement structures and the first adhesive. Additionally, the force may be nearly perpendicular to the second adhesive at the bottom surface of the carrier. The second adhesive may be located onto a surrounding portion of the carrier that substantially surrounds the protrusion structure. The second adhesive may surround the areas adjacent to the protrusion side walls and bottom wall.

It is contemplated that the first adhesive and second adhesive are the same composition, preferably an expandable structural adhesive. The third adhesive is disposed about the carrier around a carrier top portion and comprises an expandable sealant.

The protrusion structure may includes a plurality of snap fastening features that secure the carrier to the opening in the wall of the vehicle cavity. The snaps may aid in maintaining a set distance of the first adhesive to a vehicle reinforcement panel.

It is contemplated that one or more of the first, second and/or third adhesive materials is applied to the carrier prior to insertion of the structure into the vehicle cavity. It is contemplated that one or more of the first, second and/or third adhesive materials is applied to the carrier after insertion of the structure into the vehicle cavity.

The first adhesive material, the second adhesive, or both expands upon exposure to a stimulus, preferably heat. The expandable sealant (third adhesive) expands upon exposure to a stimulus, preferably heat.

It is contemplated that a method of manufacturing the reinforcing part as described above and functions to distribute loads in an automotive vehicle structure occasioned by a roof crush loading condition may have one or more following steps. Performing computer modeling to simulate load conditions upon a structure of a vehicle, the vehicle having a roof and a sill, occasioned by a load applied in a direction toward the sill upon the roof from load external of the roof. Based upon results of the computer modeling of step (a), designing a part that includes a carrier having a shear load transmission portion that projects laterally. Having an activatable material on a vertical protrusion outer wall, so that it can activated and bonded to laterally positioned structure of the vehicle, and thereby transmits at least a portion of the load laterally so that the load is taken up in a shear mode by way of the adhesive bonded structure. Manufacturing the part that is designed from step (b), wherein the part includes the carrier that includes a molded and/or pultruded polymeric portion, preferably including a fiber reinforced polymeric matrix, and an activatable adhesive material capable of being activated to form a structural foam located on at least one vertical protrusion outer wall of the laterally projecting shear load transmission portion. Optionally wherein the at least a portion of the vertical protrusion outer wall includes an outwardly projecting rib that guides a direction of expansion of the activatable material during foaming. Optionally, wherein the activatable material is applied to the vertical protrusion outer wall and to an adjoining surface that is not coplanar with the vertical protrusion outer wall in a continuous manner. Optionally, wherein the shear load transmission portion of the carrier adjoins a base portion of the carrier in a region that includes a surface or edge that is arcuate. Optionally wherein the shear load transmission portion of the carrier includes a stepped a vertical protrusion outer wall; and/or wherein the shear load transmission portion of the carrier includes a vertically oriented rib located behind the vertical protrusion outer wall at an approximate midpoint of the free end (outer protrusion wall).

The explanations and illustrations presented herein are intended to acquaint others skilled in the art with the invention, its principles, and its practical application. The specific embodiments of the present invention as set forth are not intended as being exhaustive or limiting of the invention. The scope of the invention should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The teachings herein may generally relate to structural reinforcement devices (e.g., structures). The devices described herein may also provide functions such as sealing and baffling. The reinforcement devices described herein may be specifically adapted to provide sealing, baffling, reinforcement, or load transfer/distribution within or through a cavity of a vehicle. It is also contemplated that the reinforcement structure may be applied (e.g., assembled) to various articles of manufacture such as boats, trains, buildings, homes, furniture, or the like. The term “vehicle” as used herein may be used to describe any transportation vehicle, including a boat, train, automotive vehicle, plane, motorcycle, and the like.

It is contemplated that the device of the present invention may find particular use in reinforcing and distributing an impact load associated with an impact or crush load. An impact load may be understood as a force generated by impact to a surface of a vehicle, such as during a collision or roll-over event. The impact load may be a side impact (passenger or driver side), a rear impact, or front impact. The device may be useful in reinforcing a cavity in a body panel, body pillar, crash beam, or elsewhere on a vehicle body. For example, the reinforcement structure may be disposed within a cavity of an A-Pillar, B-pillar, C-Pillar, beltline, cowl, door panel, frame system, quarter panel, dash panel, roof system, rocker panel, wheelhouse, windshield, the like, or any combination thereof. The device may absorb and/or distribute impact such that at least a portion of the impact load is not transferred into the passenger compartment. It is contemplated that in the present invention, the structural reinforcement device is specifically useful for creating sufficient strength and load paths within the vehicle body such that the vehicle performs adequately to pass a roof crush test (see roof crush event-load path direction 110), such as § 571.216a Standard No. 216a; Roof crush resistance (incorporated by reference in its entirety hereto). As shown in the federal rule, the summary is as follows: “As part of a comprehensive plan for reducing the risk of rollover crashes and the risk of death and serious injury in those crashes, this final rule upgrades the agency's safety standard on roof crush resistance in several ways. First, for the vehicles currently subject to the standard, i.e., passenger cars and multipurpose passenger vehicles, trucks and buses with a Gross Vehicle Weight Rating (GVWR) of 2,722 kilograms (6,000 pounds) or less, the rule doubles the amount of force the vehicle's roof structure must withstand in the specified test, from 1.5 times the vehicle's unloaded weight to 3.0 times the vehicle's unloaded weight. Second, the rule extends the applicability of the standard so that it will also apply to vehicles with a GVWR greater than 2,722 kilograms (6,000 pounds), but not greater than 4,536 kilograms (10,000 pounds). The rule establishes a force requirement of 1.5 times the vehicle's unloaded weight for these newly included vehicles. Third, the rule requires all of the above vehicles to meet the specified force requirements in a two-sided test, instead of a single-sided test, i.e., the same vehicle must meet the force requirements when tested first on one side and then on the other side of the vehicle. Fourth, the rule establishes a new requirement for maintenance of headroom, i.e., survival space, during testing in addition to the existing limit on the amount of roof crush. The rule also includes a number of special provisions, including ones related to leadtime, to address the needs of multi-stage manufacturers, alterers, and small volume manufacturers.” These requirements have brought additional challenges to vehicles and meeting these particular requirements as the advent of electric vehicles with massive battery packs have begun to enter the markets.

It is contemplated that the carrier may be formed of a moldable material, a pultrudable material, an extrudable material, or some combination thereof. The carrier may be formed of a polymeric material, which may be a polyamide or polyurethane material. The polymeric material may be a reinforced polymeric material. For example, the polymeric material may be a glass fiber reinforced nylon. The polymeric material may be a polyurethane. The polymeric material may be a thermoset material. The polymeric material may be a thermoplastic material. The polymeric material may be a thermoplastic epoxy material. The polymeric material may be a fiber reinforced thermoplastic epoxy material.

The carrier may include a means to affix the structural reinforcement to a surface. The carrier may be formed to absorb and/or distribute energy from an impact load. The carrier may have any size, shape, and/or configuration to affix the structural reinforcement to a surface, absorb and/or distribute energy from an impact load; provide a surface of secondary material, or any combination thereof. Features formed as part of the carrier may include a base structure and one or more projections. Such features may be integrally molded or separately formed. The carrier may be a one-piece structure or may be comprised of multiple pieces. The carrier may include one or more secondary materials which may be located only onto select portions of the carrier or may be located to substantially cover the entirety of the carrier. The carrier may include one or more portions of secondary material adjacent to one another. The carrier may include a plurality of projections. The carrier may include one or more cell-like structures. The carrier may include one or more walls. The carrier may include one or more ribs. The carrier may include one or more holes (e.g., openings, apertures, or through-holes). The one or more walls may be formed by a plurality of projections. Carriers made in accordance with the present teachings may include one or more walls having a first surface and a generally opposing second surface.

The plurality of projections may be walls, ribs, apertures, bridges, channels, bodies, attachments, reinforcements, attachments, or a combination thereof. Two or more of the plurality of projections may connect and create one or more reinforcing cells, one or more reinforcing cavities, one or more reinforcing cutaways, or a combination thereof.

The device may include one or more fasteners. The one or more fasteners may function to affix the composite reinforcement to a surface, such as one or more walls of a cavity, or to a second device. The one or more fasteners may have any size, shape, or configuration to affix the structural reinforcement to a surface. The device may include a single fastener or a plurality of fasteners. The one or more fasteners may be integrally formed with the carrier or separately formed from the carrier. The one or more fasteners may be formed from the same material as the carrier or from materials that are dissimilar from that of the carrier. The device may include one or more fasteners that are located so that they correspond with openings formed in a wall. The device may include one or more fasteners that cooperate with one or more edges of a cavity or second device. The one or more fasteners may include a threaded fastener, an opening for receiving a fastener, a tree fastener, an arrowhead fastener, a push pin fastener, a clip fastener, a hook-like fastener, a friction-fit fastener, the like, or any combination thereof. The one or more fasteners may be located into and/or through an opening of a surface, such as a cavity wall, to affix the structural reinforcement. The one or more fasteners may receive a surface, such as a protrusion or extension from a cavity wall, or a second device to affix the structural reinforcement.

The adhesive material and/or sealant material may be a material that experiences expansion and/or cure upon exposures to temperatures of between about 148.89° C. to about 204.44° C. (about 300° F. to about 400° F.) (i.e., temperatures typically experienced in automotive painting or coating operations). The adhesive material and/or material may be foamed to a volume of at least 5% greater, at least 50% greater, at least 200% greater, at least 1000% greater, at least 2000% greater, at least 5000% greater or higher relative to the original unexpanded volume.

The adhesive material and/or sealant material may be a two-part material that activates (e.g., cures, foams, or some combination thereof) when the two parts are combined. Activation may occur at room temperature.

The adhesive and/or sealant material may be an epoxy-based material such as those disclosed in U.S. Pat. Nos. 5,884,960; 6,348,513; 6,368,438; 6,811,864; 7,125,461; 7,249,415; and U.S. Patent Publication No. 2004/0076831, hereby incorporated by reference in their entirety. The adhesive and/or sealant material may include one or more phosphate ester-based components.

The adhesive materials and sealant materials may include an epoxy resin component. Epoxy resin is used herein to mean any of the conventional epoxy materials containing at least one epoxy functional group. The epoxy resins can be difunctional, trifunctional, multifunctional, combinations thereof or otherwise. Moreover, the term epoxy resin can be used to denote one epoxy resin or a combination of epoxy resins. The polymer-based materials may be epoxy-containing materials having one or more oxirane rings polymerizable by a ring opening reaction. In preferred embodiments, the adhesive and/or sealant material of this invention includes between about 2% and 70% by weight epoxy resin, more preferably between about 7% and 50% by weight epoxy resin and even more preferably between about 15% and 40% by weight epoxy resin and even possibly between about 15% and about 25% by weight epoxy resin.

The epoxy may be aliphatic, cycloaliphatic, or aromatic. The epoxy may be supplied as a solid (e.g., as pellets, chunks, pieces or the like) or a liquid (e.g., an epoxy resin) or both. As used herein, a resin is considered to be a solid resin if it is solid at a temperature of 23° C. and is considered to be a liquid resin if it a liquid at 23° C. The presence of the epoxy resin increases the adhesion, flow properties, or both of the adhesive and/or sealant. One exemplary epoxy resin may be a phenolic resin, which may be a novalac type or other type resin. For example, bisphenol A resin, bisphenol F resin, a combination thereof or the like may be employed. Moreover, various mixtures of several different epoxy resins may be employed. Examples of suitable epoxy resins are sold under the tradename DER® (e.g., DER 331, DER 661, DER 662), commercially available from the Dow Chemical Company, Midland, Mich.

It is possible that the epoxy resins used are such that the formulated adhesive and sealant are dry to the touch at ambient temperature.

Several additional polymers may be incorporated into the adhesive and/or sealant material, e.g., by copolymerization, by blending, or otherwise. For example, without limitation, other polymers that might be appropriately incorporated into the sealant material include halogenated polymers, polycarbonates, polyketones, urethanes, polyesters, silanes, sulfones, allyls, olefins, styrenes, acetates, ethylene vinyl acetates, acrylates, methacrylates, epoxies, silicones, phenolics, rubbers, polyphenylene oxides, terphthalates, or mixtures thereof. Other potential polymeric materials may be or may include, without limitation, polyethylene, polypropylene, polystyrene, polyolefin, polyacrylate, poly (ethylene oxide), poly (ethyleneimine), polyester, polyurethane, polysiloxane, polyether, polyphosphazine, polyamide, polyimide, polyisobutylene, polyacrylonitrile, poly (vinyl chloride), poly (methylmethacrylate), poly (vinyl acetate), poly (vinylidene chloride), polytetrafluoroethylene, polyisoprene, polyacrylamide, polyacrylic acid, polymethacrylate, and polyacetals.

The adhesive and/or sealant material may each include one or more curing agents that assist the adhesive and/or sealant material in curing by crosslinking of the polymers, epoxy resins and other ingredients in the material. The amount of curing agents or curing agent accelerators present in the adhesive and/or sealant material range from about 0.001% by weight to about 9% by weight and more typically from about 0.2 to about 6 wt %, and even more typically from about 2 wt % to about 6% by weight. The curing agent materials can be selected from aliphatic or aromatic amines or their respective adducts, amidoamines, polyamides, cycloaliphatic amines, anhydrides, polycarboxylic polyesters, isocyanates, phenol-based resins (e.g., phenol or cresol novolak resins, copolymers such as those of phenol terpene, polyvinyl phenol, or bisphenol-A formaldehyde copolymers, bishydroxyphenyl alkanes or the like), dihydrazides, sulfonamides, diamino diphenyl solfone, anhydrides, mercaptans, imidazoles, ureas, tertiary amines, BF3 complexes or mixtures thereof. Particular preferred curing agents include modified and unmodified polyamines or polyamides such as triethylenetetramine, diethylenetriamine tetraethylenepentamine, cyanoguanidine, dicyandiamides and the like.

The adhesive and/or sealant composition may be activatable (e.g., foamable) and as such it may contain one or more foaming agents that typically produce inert gases that transform the adhesive/sealant into an open and/or closed cellular structure. The expansion can help to improve adhesion, sealing capability, acoustic damping, reduce density, or a combination of factors. Amounts of blowing agents and blowing agent accelerators that can be used can vary widely depending upon the type of cellular structure desired, the desired amount of expansion of the adhesive and/or sealant material, the melt viscosity of the materials, and the desired rate of expansion.

Exemplary ranges for the amounts of blowing agents and blowing agent accelerators in the activatable material range from about 0.001% by weight to 2%.

Chemical blowing agents that may be used include one or more nitrogen containing groups such as amides, amines, and the like. Examples of suitable blowing agents include dinitrosopentamethylenetetramine, azodicarbonamide, dinitroso-pentamethylenetetramine, 4,4′oxy-bis-(benzene-sulphonylhydrazide), trihydra-zinotriazine and N, N′-dimethyl-N,N′-dinitroso-terephthalamide.

Physical blowing agents may additionally or alternatively be employed. As one example, solvent filled polymeric shells that soften and expand upon exposure to heat may be used. A typical example is sold under the trade name Expancel by Akzo Nobel.

The adhesive and/or sealant material may each include one or more physical properties that include Tensile/Compressive modulus (_{T}M/C_{M}), strength (T_{S}/C_{S}), and elongation (T_{E}), and Lap Shear (L_{S}) and T-Peel (T_{P}) that may range as follows: T_{M} (per JISK 6301-1 MET dog bone specimen, 3 mm cured thickness, 5 mm per minute test rate) ranges from at least about 100 MPa or more, preferably at least about 500 MPa or more, more preferably about at least 700 MPa or more, and most preferably about at least about 1000 Mpa or more. It is also preferable that the T_{M} is less than about 3000 MPa, more preferably less than about 2000 MPa, and most preferably less than about 1500 MPa. T_{S} (per JISK 6301-1 MET dog bone specimen, 3 mm cured thickness, 5 mm per minute test rate) ranges from at least about 1.0 MPa or more, preferably at least about 5.0 MPa or more, more preferably about at least 7.0 MPa or more, and most preferably about at least about 10.0 Mpa or more. It is also preferable that the T_{S} is less than about 5.00 MPa, more preferably less than about 11.00 MPa, and most preferably less than about 20.0 MPa. T_{E} (per JISK 6301-1 MET dog bone specimen, 3 mm cured thickness, 5 mm per minute test rate) ranges from at least about 0.25% or more, preferably at least about 0.50% or more, more preferably about at least 1.0% or more, and most preferably about at least about 2.5% or more. It is also preferable that the T_{E} is less than about 1.25%, more preferably less than about 2.5%, and most preferably less than about 3.0%. C_{M} (30 mm×60 mm cured cylinder, 12.7 mm per minute test rate) is ranges from at least about 50 MPa or more, preferably at least about 250 MPa or more, more preferably about at least 350 MPa or more, and most preferably about at least about 500 MPa or more. It is also preferable that the C_{M} is less than about 1500 MPa, more preferably less than about 1000 MPa, and most preferably less than about 750 MPa. C_{S} (30 mm×60 mm cured cylinder, 12.7 mm per minute test rate) is ranges from at least about 50 MPa or more, preferably at least about 250 MPa or more, more preferably about at least 350 MPa or more, and most preferably about at least about 500 MPa or more. It is also preferable that the C_{S} is less than about 5.0 MPa, more preferably less than about 11.0 MPa, and most preferably less than about 20.0 MPa. Lap Shear (L_{S}—1.5 mm EG-60, 3 mm bondline, 25.4 mm overlap, test rate 50.8 mm/minute) ranges from at least about 1.0 MPa or more, preferably at least about 2.5MPa or more, more preferably about at least 5.0 MPa or more, and most preferably about at least about 10.0 MPa or more. It is also preferable that the L_{S} is less than about 6.00 MPa, more preferably less than about 10.00 MPa, and most preferably less than about 15.0 MPa. T-Peel (T_{P}—0.75 mm EG-60, 1.5 mm bondline, test rate 254 mm/minute) ranges from at least about 1.0 N/mm or more, preferably at least about 2.5N/mm or more, more preferably about at least 5.0 N/mm or more, and most preferably about at least about 10.0 N/mm or more. It is also preferable that the L_{S} is less than about 6.00 N/mm, more preferably less than about 10.00 N/mm, and most preferably less than about 15.0 N/mm. It is contemplated that adhesive and/or sealant material is a non-solid rubber adduct containing structural foam for NVH and crash applications.

It is contemplated that examples of two types of adhesives to be utilized in the preferred illustrative embodiments are commercially available from L&L and are a highly expandable structural foam (first adhesive/second adhesive 80/90) and a less expandable acoustic treatment sealant (third adhesive 100).

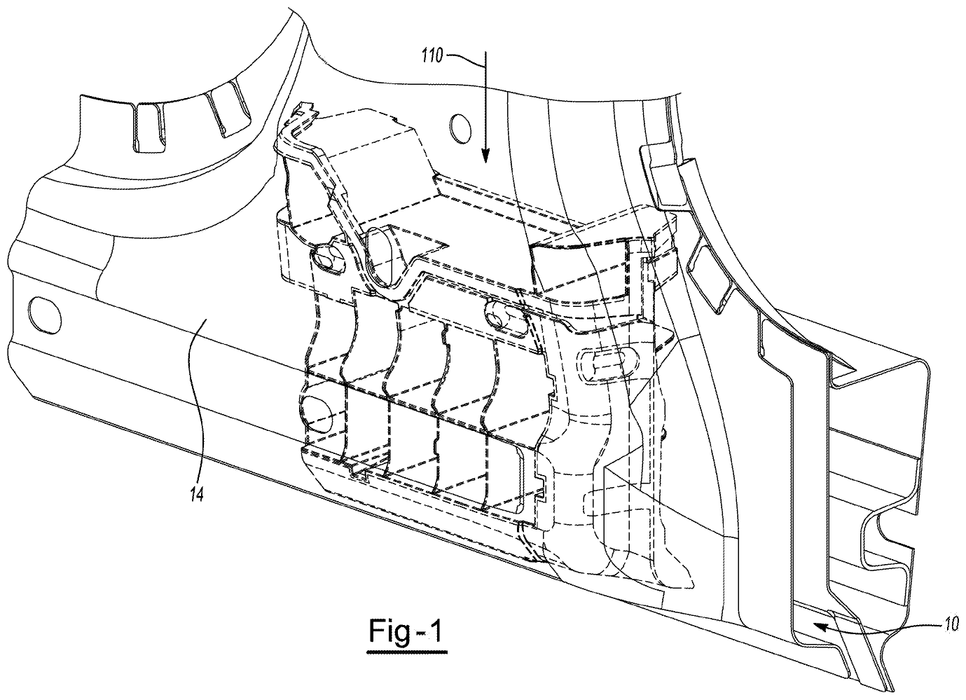

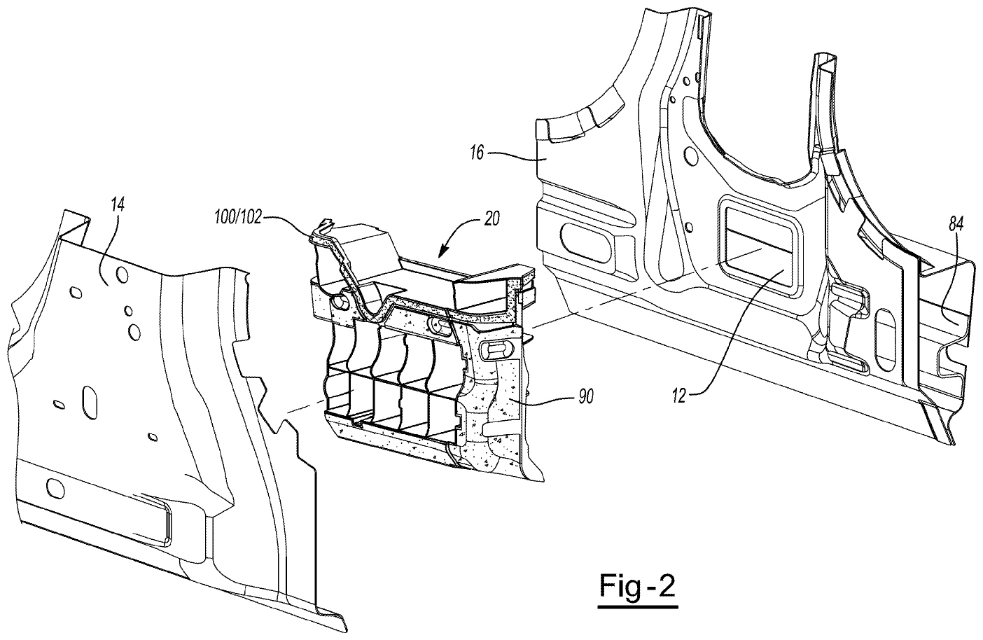

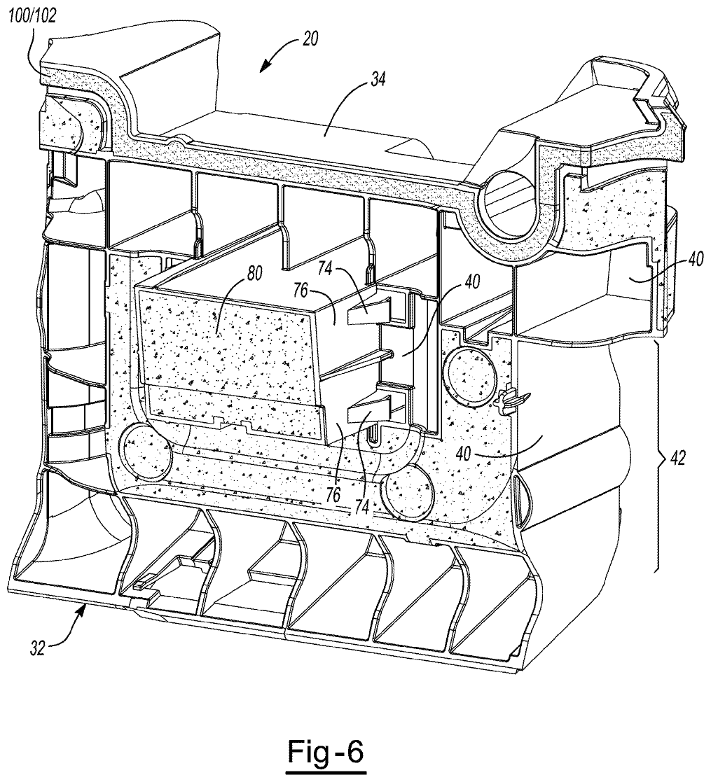

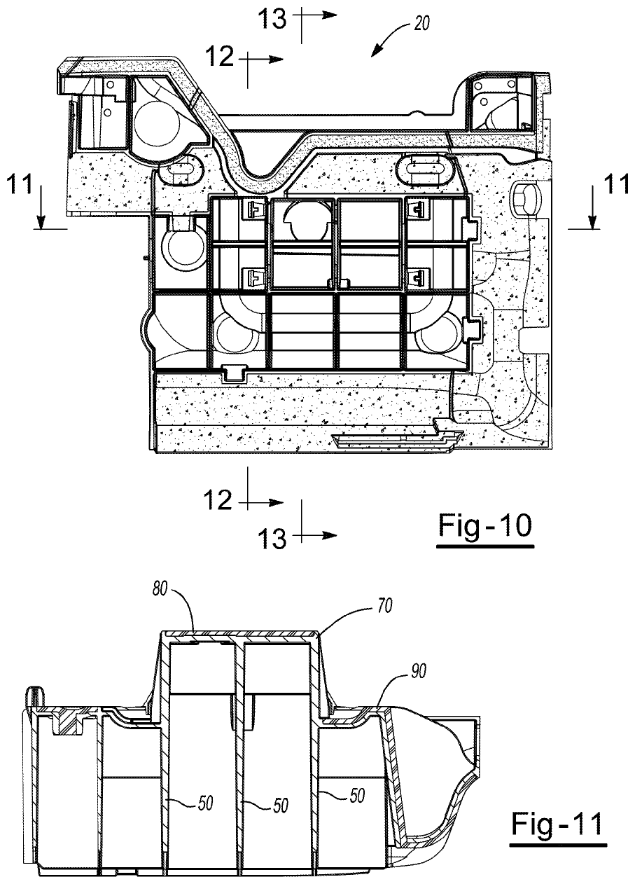

A preferred illustrative embodiment of the present invention can be seen in all the figures. FIG. 1 shows the inventive structural reinforcement 20 in-situ (dotted line—as installed) in the vehicle cavity 10, and FIGS. 2-5 show exploded views of the reinforcement and vehicle body panels (14/16) that make up the vehicle cavity 10 and vehicle reinforcement panels 84/86. Referring to FIGS. 6-13, the inventive structural reinforcement 20 can be seen from various angles and select sectional views. The structural reinforcement 20 is shown including a carrier 30 having a base wall 40, a plurality of continuous vertical reinforcement structures 50, a plurality of horizontal reinforcement structures 60, and a protrusion structure 70. The carrier 39 may have areas that include a first adhesive 80, a second adhesive 90 and a third adhesive 100. It is also contemplated that the protrusion structure 70 may include a vertical protrusion outer wall 72 and a plurality of snap features 74 (preferably disposed on or part of the protrusion side walls 76) that secure the reinforcement 20 to the vehicle cavity 10 through the hole 12 in vehicle inner panel 16. Each of the major elements will be discussed in further detail in the other sections of this specification.

### Vehicle Cavity 10

It is contemplated that the vehicle cavity may be part of an A-Pillar, B-pillar, C-Pillar, beltline, cowl, door panel, frame system, quarter panel, dash panel, roof system, rocker panel, wheelhouse, windshield, the like, or any combination thereof. In this preferred embodiment the cavity 10 is part of the frame system of the vehicle in the area below the B-pillar. The individual components of the frame system may be metallic, polymeric, or any combination thereof. The cavity includes at least one opening 12 that allows for part of the reinforcement 20 to protrude through and adhesively interact/bond with an inner and outer reinforcement panels 84/86. Of particular interest is the bonding of the carrier 30 to one or both of the panels 84/86 via the first adhesive 80, wherein the adhesive sees shear loads when subject to a roof crush event (load path direction 110), which contributes to the ability of the vehicle as a whole passing such a roof crush test. It is contemplated that a shear load is defined as a force or shear vector that is a vector has an equal or greater amount of force in the shear direction compared to the compression direction for a given adhesive area. In other words, a shear vector may be a force vector that is generally parallel (plus or minus about 45 degrees) to adhesive the bond line and a compressive vector may be a force vector that is generally perpendicular (plus or minus about 45 degrees) to adhesive the bond line. For example, looking at FIG. 13, the force provided along load path 110 would put adhesive 80 in shear and adhesive 90 in compression.

### Structural Reinforcement 20/Carrier 30

It is contemplated that structural reinforcement 20 is an assembly of components such as the carrier 30 and various adhesives (80/90/100) as discussed earlier in the specification. It is also contemplated that reinforcement 20 is preferably provided as a completed assembly for installation in the vehicle cavity 10, but it is also contemplated that the adhesive(s) may be applied to the full assembly once the carrier is in place in the cavity and adhesive is pumped in or added later.

In the preferred illustrative embodiment, it is contemplated that the carrier 30 has a base wall 40, a bottom carrier surface 32, a top carrier surface 34, a portion of the bottom of the carrier 36, a carrier top portion 38, a surrounding portion 42 (surrounding the protrusion structure 70), a plurality of continuous vertical reinforcement structures 50, a plurality of horizon reinforcement structures 60, a protrusion structure 70, a vertical protrusion outer wall 72, and a plurality of snap features 74. It is also contemplated that the first adhesive 80 is the adhesive that is disposed on vertical protrusion outer wall 72 (wherein it sees shear loads), the second adhesive is disposed on the base wall 40 (or at least on a portion of the base wall) and the third adhesive is disposed about the carrier 30 around a carrier top portion 38. It is contemplated that the first adhesive 80 covers a substantial majority of the surface area of the wall 72, preferably about at least 50% of the surface area or more, more preferably about 75% of the surface area or more, and most preferably about 95% or more. Also, the first adhesive 80 may cover 55% of the surface area of wall 72 or less, more preferably about 80% of the surface area of wall 72 or less, and most preferably about 99.9% of the surface area of wall 72. In this preferred illustrative embodiment, the first adhesive 80 and the second adhesive 90 is a structural adhesive (as described above and may in fact be the same composition) and the third adhesive 100 is preferably composed of an expandable sealant. It is also contemplated that at least a portion of the second adhesive 90 sees compressive loads when subject to the roof crush event (load path direction/shear vector 110).

### Continuous Vertical Reinforcement Structures 50/Horizontal 60

It is contemplated that the carrier in the preferred illustrative embodiment includes a plurality of continuous vertical reinforcement structures 50 that span continuously from the bottom carrier surface 32 to the top carrier surface 34. These structures 50 function to aid in the distribution of the vertical roof crush loads 110 through the structural reinforcement 20 to the vehicle frame system. It is contemplated that portions of the structures 50 span horizontally from the vertical protrusion outer wall 72 to the opposite side of the carrier 30.

It is contemplated that, and in the preferred illustrative embodiment, these structures 50 may be in the form of what is commonly known as ribs. In the preferred illustrative embodiment, the ribs 50 will have a thickness (at its base) of about 1.5 to 5 mm, more preferably about 2.0 to 4.5 mm, and most preferably about 2.5 To 3.5 mm. In contrasting the plurality of horizon reinforcement structures 60 to the vertical 50, it is contemplated that the vertical ribs 50 should be about 1 to 100 percent thicker, more preferably about 10 to 75 percent thicker, and most preferably about 25 to 50 percent thicker given the vertical loads seen to pass the roof crush test. It is also contemplated that the ribs 50 preferably extend the entire height (H_{C}) of the carrier 30 (from the bottom surface 32 to the top surface 34, but in some areas/circumstances less than the entire height H_{C} of the carrier). In this case, a portion of ribs 50 may only stretch about 50 to 95% of H_{C} but is preferably this is only in localized areas that do not need to directly transfer of the roof crush load between the top surface 34 to bottom surface 32.

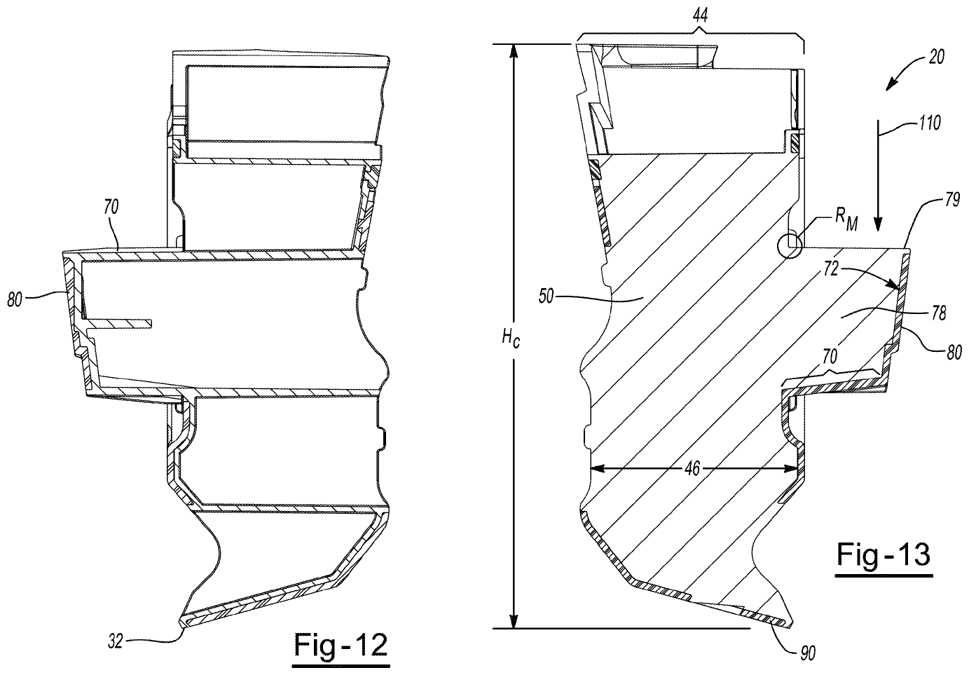

It is also contemplated that one or more of these vertical structures 50 (as seen in FIGS. 11-13) are part of the protrusion structure 70, and more particularly part of the outer vertical side walls 76 of the protrusion 70 and in the center 78 of the protrusion 70. This may aid in the transfer of the roof crush load to the inner and outer vehicle reinforcement panels 84/86.

### Protrusion Structure 70

It is contemplated that the protrusion structure 70 functions to aid in the transfer of the roof crush load from the main body portion 44 of the carrier to the inner and outer vehicle reinforcement panels 84/86 (which are located outside of cavity 10). The structure is basically comprising a box like structure with the vertical side walls 76 and an outer wall 72 (and potentially one or more horizontal walls). Outer wall 72 may be flat or may have a step feature and may also have an outwardly projecting rib 79 that may aid in directing the expansion of the first adhesive 80. It is contemplated that this structure 70 is cantilevered generally horizontally from the main body portion 44 and extends horizontally no more than about 90% of the horizontal depth 46 of the main body portion 44 or less; preferably no more than about 70% of the depth 46, more preferably no more than about 60%, and most preferably no more than about 50% of the depth 46. It may be cantilevered at least 10% of the depth 46 or more, preferably about at least 20% or more, and most preferably about 35% or more. As already discussed, the outer side walls 76 of the structure 70 is preferably coextensive with the respective vertical reinforcement structures 50 (e.g., see FIG. 13) and has at least one center wall 78 (also coextensive) disposed in between the side walls 76. It is contemplated that a series (2 or more) of “center walls 78” may be disposed between the outer side walls 76. In a preferred embodiment, the distance between the respective walls 76/78 are no more than about 2 cm, more preferably no more than about 4 cm, and most preferably no more than about 6 cm. The distance may be about 12 cm or less, more preferably about 10 cm or less and most preferably about 7 cm or less. It is contemplated that where the structure's walls 76/78 transition to the respective vertical reinforcement structures 50 of the main body portion 44, there is a minimum radius RM. This minimum radius is preferred so what is commonly known as a stress riser is not created. RM is preferably about 0.1 mm or more, more preferably about 0.5 mm or more, and most preferably about 1.0 mm or more. RM is preferably about 4.0 mm or less, more preferably about 2.0 mm or less, and more preferably about 1.5 mm or less.

### Adhesives 80/90/100

It is contemplated that in the preferred illustrative embodiment, that the first and second adhesives are both expandable epoxy-based structural adhesives (such as L5905 adhesive by L&L) as described in previous sections of the specification and the third adhesive is an expandable sealing adhesive (such as L2806 adhesive by L&L). It is preferred that the first adhesive has an unexpanded thickness of about 1.5 to 3.5 mm, more preferably about 2.0 to 3.0 mm thick and most preferably about 2.5 to 3.0 mm. It is also worth noting that the gap (or set distance 82) between the unexpanded first adhesive 80 and the outer vehicle reinforcement panel be about 1.0 to 4.0 mm, more preferably about 2.0 to 3.5 mm, and most preferably about 2.5 to 3.0 mm. In the ideal conditions, the expanded first adhesive fills the gap 82 with a total thickness of about 5.5 mm plus/minus about 10 to 50 percent, more preferably about plus/minus 5 to 30 percent, and most preferably about 1 to 20 percent. It is also preferred that the second adhesive 90 has an unexpanded thickness of about 1.5 to 3.5 mm, more preferably about 2.0 to 3.0 mm thick and most preferably about 2.5 to 3.0 mm. It is also worth noting that the general gap between the unexpanded second adhesive 90 and the adjoining wall of the cavity 10 is about 0.5 to 10.0 mm, more preferably about 1.0 to 5.5 mm, and most preferably about 1.5 to 4.0 mm. In the ideal conditions, the expanded second adhesive fills the space with a total thickness of about 6.5 mm plus/minus about 10 to 50 percent, more preferably about plus/minus 5 to 30 percent, and most preferably about 1 to 20 percent. It is contemplated that the third adhesive 100 may expand a greater amount than that of the first or second adhesives, and functions as a sealant that prevents liquid and dust from entering the cavity 10 from above the reinforcement 20.

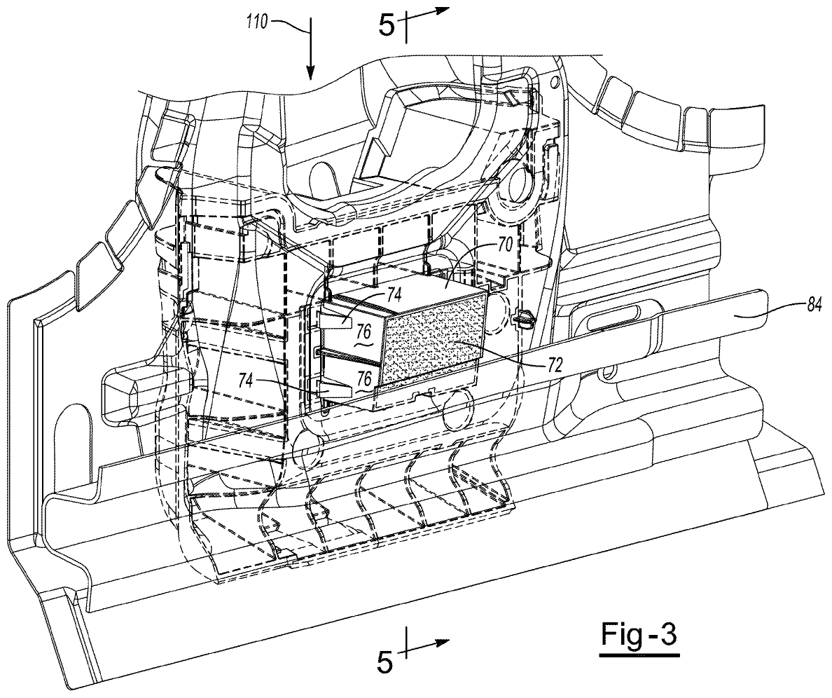

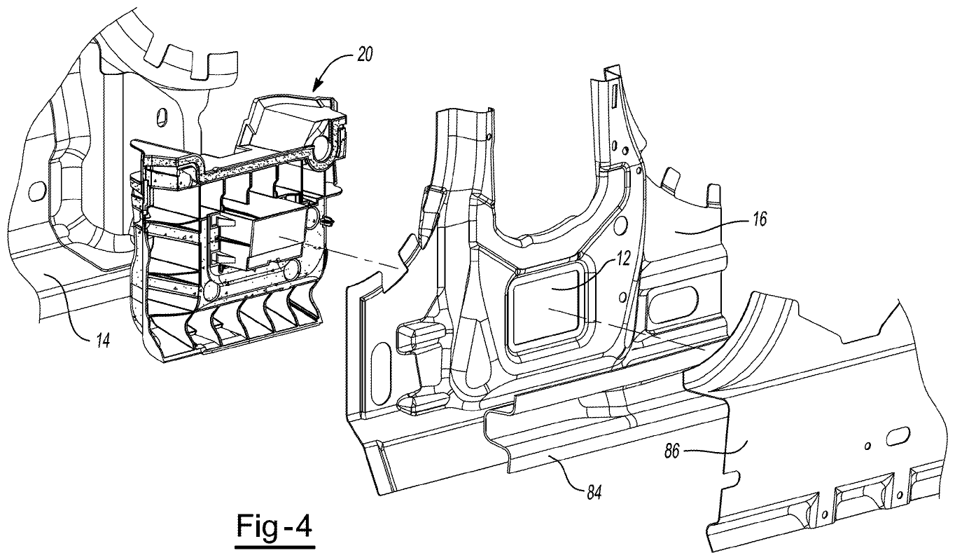

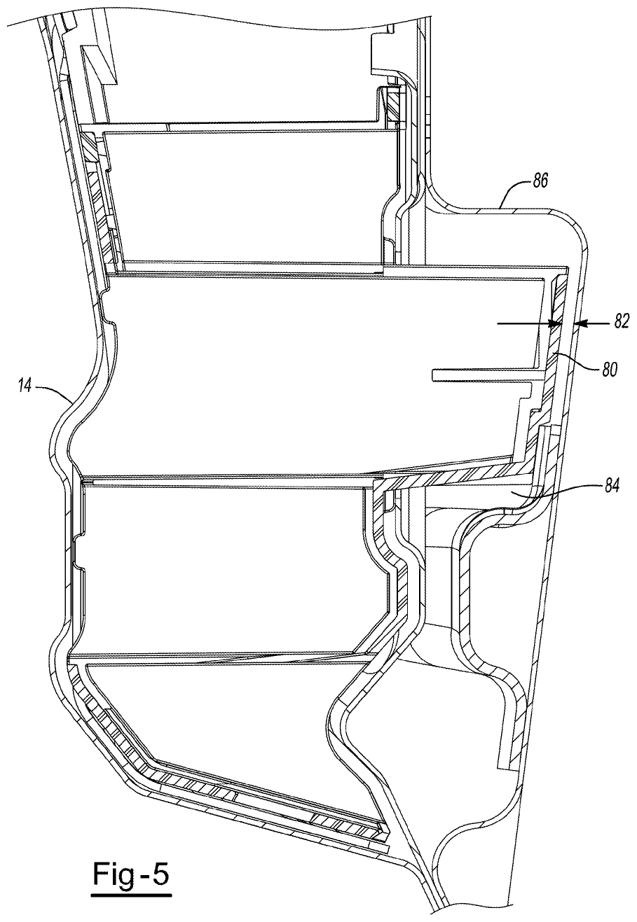

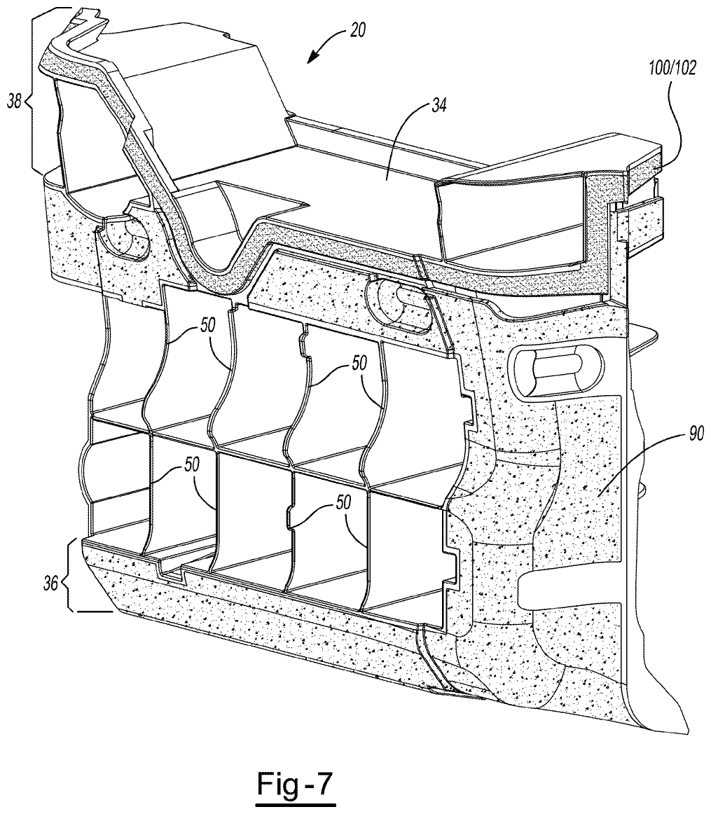

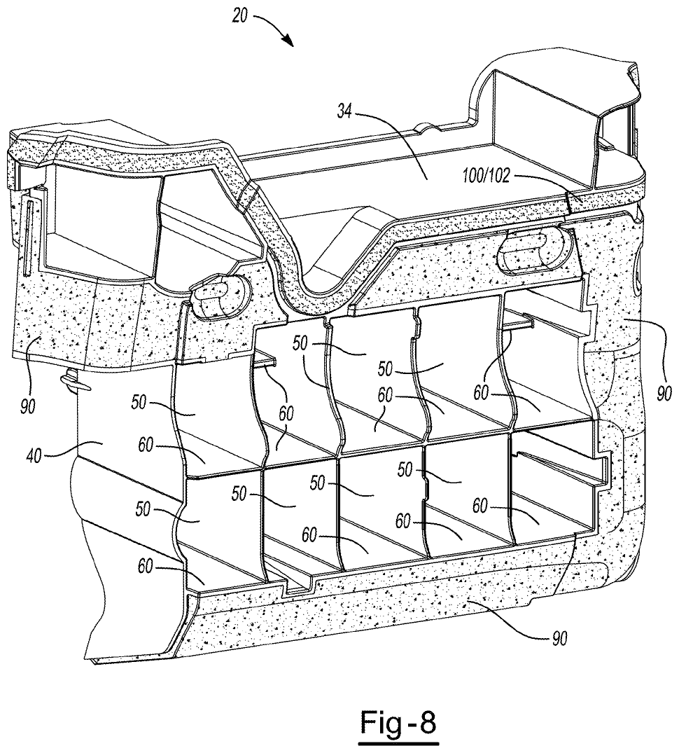

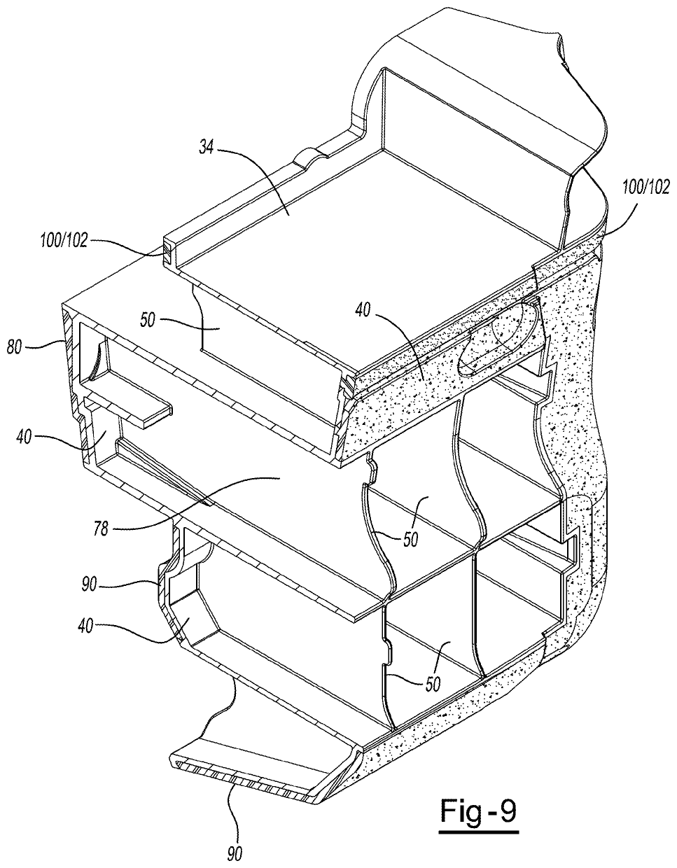

Now turning to the individual drawing figures for further details of the preferred illustrative embodiment. FIG. 1 shows the carrier 30 (in dotted line, without the adhesives shown) in situ within the vehicle cavity 10 and showing the load direction/path 110 for a roof crush test/event. FIG. 2 shows an exploded view of the structural reinforcement (e.g., carrier 20 with the adhesives 100 and 90 shown) and the body panels 14 and 16, with the hole 12 and inner and outer reinforcement panels 84 and 86. FIG. 3 shows the opposite view as shown in FIG. 1 and where the protrusion structure 70 of the reinforcement 20 can be seen protruding through the hole 12. Additionally, two of the snap features 74 can also be seen. FIG. 4 shows the same exploded view as in FIG. 2 from the opposing side of the vehicle. FIG. 5 is a sectional view of FIG. 3, showing the set distance/gap 82 that is between the outer reinforcement panel 86 and the first adhesive 80. FIG. 6 is a perspective view of the structural reinforcement 20, looking from the outside of the vehicle. This figure at least identifies the base wall 40, the surrounding portion 42, the protrusion vertical side wall 76, two more of the snap features 74, the top carrier surface 34, and the bottom carrier surface 32. FIGS. 7 and 8 are two perspective views of the structural reinforcement 20, looking from the inside of the vehicle. These figures identify various reinforcement structures 50/60 (ribs in this case), locations for adhesive 90 and 100, carrier top surface 34, and a portion 36 of the bottom of the carrier. FIG. 9 is a partial sectional view of the reinforcement 20 with additional call-outs for the ribs 50 and the center 78 of the protrusion 70.

The reinforcement structure may be formed by a combination of molding steps and extrusion steps. The base reinforcing structure may be formed by an injection molding step. The adhesive material may be applied to the base reinforcing structure by a second molding process (e.g., a two-shot molding process) whereby the adhesive material is injection molded onto the base reinforcing structure. The sealant material may then be extruded onto the base reinforcing structure. The extrusion process may be completed by a traditional twin screw extruder, or may be extruded by a robotic extrusion system, including a mini applicator (e.g., mini extruder) attached to a robotic arm. The base reinforcing structure may thus be removed from a molding device (such removal may be automated) and moved in-line to a location where the sealant material is extruded onto a portion of the base reinforcing structure.

A manufacturing method is also contemplated within the scope of the present invention. It is contemplated that a method of manufacturing the above described reinforcing part (structural reinforcement 20) to distribute loads in an automotive vehicle structure occasioned by a roof crush loading condition, comprising the steps of: performing computer modeling to simulate load conditions upon a structure of a vehicle, the vehicle having a roof and a sill, occasioned by an load applied in a direction toward the sill upon the roof from load external of the roof; based upon results of the computer modeling of step (a), designing a part that includes a carrier having a shear load transmission portion that projects laterally, and has an activatable material on a free end, so that it can activated and bonded to laterally positioned structure of the vehicle, and thereby transmits at least a portion of the load laterally so that the load is taken up in a shear mode by way of the adhesive bonded structure; and manufacturing the part that is designed from step (b), wherein the part includes the carrier 30 that includes a molded and/or pultruded polymeric portion, preferably including a fiber reinforced polymeric matrix, and an activatable adhesive material (e.g. first adhesive 80) capable of being activated to form a structural foam located on at least one free end of the laterally projecting shear load transmission portion; and wherein the at least a portion of the free end includes an outwardly projecting rib that guides a direction of expansion of the activatable material during foaming; wherein the activatable material is applied to the free end and to an adjoining surface that is not coplanar with the free end in a continuous manner; wherein the shear load transmission portion of the carrier adjoins a base portion of the carrier in a region that includes a surface or edge that is arcuate; wherein the shear load transmission portion of the carrier includes a stepped free end surface; and/or wherein the shear load transmission portion of the carrier includes a vertically oriented rib located behind the free-end at an approximate midpoint of the free end.

### General Teachings Applicable to All Embodiments

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference in their entirety for all purposes. Other combinations are also possible as will be gleaned from the following claims, which are also hereby incorporated by reference into this written description.

Adhesive within the present teachings can mean any of the activatable materials described. It may be a material activated to form a structural foam, to form a sealant, to form an acoustic foam or any combination. The adhesive (when cured or otherwise hardened) thus may have a relatively high compression and or tensile modulus (e.g., greater than about 100 MPa). The adhesive may have a relatively low compression and/or tensile modulus (e.g., below about 10 MPa). Adhesive can be applied to a carrier by one or any combination of overmoulding, multi-shot (e.g., two or three shot injection molding); pumping through an orifice (e.g., a die and/or an opening in a structure in which a reinforcement without adhesive is positioned). Adhesive may be applied by extrusion; by pultrusion; by fastening a mass (e.g., a mass that has been extruded and then die cut). The carrier structure may have one or more portions (whether space spaced with intervening structure, directly adjoining (potentially even sharing a common wall) or both. One or more of the portions may be cellular in nature, in that a wall structure defines discrete hollow cavities. In an xyz Cartesian system in which planes could be defined along each of the xyz axes, one or more (e.g., a majority, more than two thirds, more than three quarters or more of one or more cells may be fully open and/or partially blocked by a structure that is or becomes part of the carrier or overall part in at least one of such planes. The part may have one or more average overall perimeters in each of the xyz directions along the part length. Two or more different adhesives may be used on or as part of a carrier. They may each differ in one or more processing characteristics, physical properties and/or mechanical properties. Examples of such differences may include activation temperature for curing and/or expansion, expansion capacity (if the material is expandable); extent of cross linking (if any); compressive modulus; sound transmission. The adhesives, and/or any walls that are part of the carrier may have one or more average thicknesses over the part. If more than one average thicknesses is present, the average difference in thicknesses may range from about 1.1:1, to about 20:1, more preferably about 1.3:1 to about 10:1; still more preferably about 1.5:1 to about 4:1. Average thicknesses are determined by taking at least 20 different measurements along each of the xyz axes of the parts, and averaging them, after dismissing the highest and the lowest measured values. Wall thicknesses of any part of the carrier may change along any of the xyz axes. The change can be continuous, in stepped increments, or both. Molded parts herein are expected to have some minimal draft angle and/or dimensional tolerance. Accordingly, numerical values specking “substantially” shall encompass within 10% of the recited value or may also be limited to within 5% of the stated value.

Parts herein may be designed with the use of computer aided design (e.g., modeling using finite element analysis). Such computing techniques may be employed in a step of designing a part, with modeling to simulate conditions to which the part may be subjected in use. Based upon how the part responds to simulated loads applied via the simulated conditions, the parts design may be re-configured. The results of computer modeling may be employed for design of one or more of carrier wall thicknesses, carrier cell dimensions, carrier dimensions, location of adhesive, adhesive thicknesses, carrier fastening device locations, or any combination thereof.

Any use of the term “harden” is not intended as being limited to only thermosetting materials. Though it refers to a condition resulting from post-curing of a thermoset adhesive, it also can refer to a condition resulting when a thermoplastic polymer containing adhesive is below the melting point or the glass transition temperature of the thermoplastic polymer. In both scenarios one particular consideration for “hardening” is that the material exhibits rigidity like a solid and is significantly more resistant to flow as compared with the material in a liquid state.

The disclosures of all articles and references, including patent applications and publications, are incorporated by reference in their entirety for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist of, or consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

### Elements

10 a vehicle cavity
12 opening in a wall of inner vehicle panel
14 outer vehicle panel
16 inner vehicle panel
20 a structural reinforcement
30 a carrier
32 a bottom carrier surface
34 a top carrier surface
36 a portion of the bottom surface of the carrier
38 a carrier top portion
40 a base wall
42 a surrounding portion
44 main body portion
46 horizontal Depth
50 a plurality of continuous vertical reinforcement structures
60 a plurality of horizon reinforcement structures
70 a protrusion structure
72 a vertical protrusion outer wall (free end)
74 a plurality of snap features
76 protrusion vertical side wall
78 protrusion center/center wall
79 an outwardly projecting rib
80 a first adhesive
82 a set distance
84 an inner vehicle reinforcement panel
86 an outer vehicle reinforcement panel
90 a second adhesive
100 a third adhesive
102 a sealant or other adhesive
110 a roof crush event (load path direction/shear vector/Z-axis)
NS a stimulus
H_{C} height between elements 32-34
R_{M} minimum radius

1. A structural reinforcement for a vehicle cavity comprising:
a carrier including:
a base wall and a plurality of continuous vertical reinforcement structures that span from a bottom carrier surface to a top carrier surface and a plurality of horizon reinforcement structures;
a protrusion structure projecting from the base wall including a vertical protrusion outer wall with a first adhesive disposed thereon and two protrusion vertical side walls, wherein the protrusion outer wall protrudes through an opening in a wall of the vehicle cavity;
a second adhesive disposed on peripheral portions of the carrier including a portion of the bottom surface of the carrier;
wherein the first adhesive is in shear and the second adhesive that is disposed on the portion of the bottom surface is in compression when a force is applied in a shear vector.

2. The structural reinforcement of claim 1, wherein the continuous vertical reinforcement structures include ribs that are about 3 to 5 mm in average thickness along their length and/or have an average thickness that differs from the average thickness of vertically oriented ribs elsewhere in the reinforcement.

3. The structural reinforcement of claim 2, wherein the reinforcement is configured to provide improved resistance to shear (as compared with a vehicle that omits such reinforcement) in response to roof crush load, and preferably a force applied in a shear vector subjects the carrier to loads nearly parallel to the vertical reinforcement structures and the first adhesive and nearly perpendicular to the second adhesive at the bottom surface of the carrier.

4. The structural reinforcement of claim 1, through 3, wherein the first adhesive and second adhesive are the same composition, preferably an expandable structural adhesive.

5. The structural reinforcement of claim 2, wherein a third adhesive is disposed about the carrier around a carrier top portion and comprises an expandable sealant.

6. The structural reinforcement of claim 3, wherein the plurality of horizon reinforcement structures are ribs that have an average thickness that is at least 30 percent thinner than the ribs of the vertical reinforcement structures.

7. The structural reinforcement of claim 2, wherein the protrusion structure includes a plurality of snap fastening features that secure the carrier to the opening in the wall of the vehicle cavity and maintain a set distance of the first adhesive to a vehicle reinforcement panel.

8. The structural reinforcement of claim 1, wherein the second adhesive is located onto a surrounding portion of the carrier that substantially surrounds the protrusion structure.

9. The structural reinforcement of claim 5, wherein one or more of the first, second and/or third adhesive materials is applied to the carrier prior to and/or after insertion of the structure into the vehicle cavity.

10. The structural reinforcement of claim 1, wherein the first adhesive material, the second adhesive, or both expands upon exposure to a stimulus, preferably heat.

11. The structural reinforcement of claim 5, wherein the expandable sealant expands upon exposure to a stimulus, preferably heat.

12. The structural reinforcement of claim 1, wherein the two vertical side walls are coextensive with two of the plurality of continuous vertical reinforcement structures and a center wall is disposed between the two vertical side walls and is also coextensive with its respective continuous vertical reinforcement structure.

13. The structural reinforcement according to claim 1, wherein the protrusion outer wall includes two planar surfaces that are stepped apart from each other and additionally include one or more ridges.

14. The structural reinforcement of claim 13, wherein the continuous vertical reinforcement structures are ribs that are about 3 to 5 mm in thickness.

15. The structural reinforcement of claim 13, wherein the roof crush event subjects the carrier to a force that loads nearly parallel to the vertical reinforcement structures and the first adhesive and nearly perpendicular to the second adhesive at the bottom surface of the carrier.

16. The structural reinforcement of claim 15, wherein the first adhesive and second adhesive are the same composition of expandable structural adhesive.

17. The structural reinforcement of claim 13, wherein a third adhesive is disposed about the carrier around a carrier top portion and comprises an expandable sealant.

18. The structural reinforcement of claim 14, wherein the plurality of horizon reinforcement structures are ribs that are at least 30 percent thinner than the ribs of the vertical reinforcement structures.

19. The structural reinforcement of claim 13, wherein the protrusion structure includes a plurality of snap features that secure the carrier to the opening in the wall of the vehicle cavity and maintain a set distance of the first adhesive to a vehicle reinforcement panel.

20. A method of manufacturing a reinforcing part as described in claim 1 to distribute loads in an automotive vehicle structure occasioned by a roof crush loading condition, comprising the steps of:
a) Performing computer modeling to simulate load conditions upon a structure of a vehicle, the vehicle having a roof and a sill, occasioned by an load applied in a direction toward the sill upon the roof from load external of the roof;
b) Based upon results of the computer modeling of step (a), Designing a part that includes a carrier having a shear load transmission portion that projects laterally, and has an activatable material on a vertical protrusion outer wall, so that it can activated and bonded to laterally positioned structure of the vehicle, and thereby transmits at least a portion of the load laterally so that the load is taken up in a shear mode by way of the adhesive bonded structure; and
c) Manufacturing the part that is designed from step (b), wherein the part includes the carrier that includes a molded and/or pultruded polymeric portion, preferably including a fiber reinforced polymeric matrix, and an activatable adhesive material capable of being activated to form a structural foam located on at least one vertical protrusion outer wall of the laterally projecting shear load transmission portion; and
wherein the at least a portion of the vertical protrusion outer wall includes an outwardly projecting rib that guides a direction of expansion of the activatable material during foaming;
wherein the activatable material is applied to the vertical protrusion outer wall and to an adjoining surface that is not coplanar with the vertical protrusion outer wall in a continuous manner;
wherein the shear load transmission portion of the carrier adjoins a base portion of the carrier in a region that includes a surface or edge that is arcuate;
wherein the shear load transmission portion of the carrier includes a stepped a vertical protrusion outer wall; and/or
wherein the shear load transmission portion of the carrier includes a vertically oriented rib located behind the vertical protrusion outer wall at an approximate midpoint of the free end.
